(19) United States
(12) Patent Application Publication
(10) Pub. No.: US 2006/0275919 A1
(43) Pub. Date: Dec. 7, 2006

(54) Methods for extraction and concetration of hydrophilic compounds from hydrophobic liquid matrices

(76) Inventors: Charlotte Lindhardt, Newport (GB); Tony Ancrum, Southampton (GB); Alan Michael Davies, Pontypridd (GB); Paul Kau, Pontrypridd (GB)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/568,529

(22) PCT Filed: Jul. 5, 2004
(86) PCT No.: PCT/EP04/07290

§ 371 Date: Feb. 17, 2006

(30) Foreign Application Priority Data
Aug. 20, 2003 (EP) 03018908.8

(51) Int. Cl. G01N 1/00

(52) U.S. Cl. 436/177; 436/178

(57) ABSTRACT

Methods for extraction and concentration of hydrophilic compounds, biological materials or particles dispersed or distributed in hydrophobic liquid matrices are disclosed. In order to improve yield the extraction is carried out using a capture solution comprising an extractant. The extract is well suited for the purpose of detection and/or quantification of contaminants in hydrophobic liquids. The preferred extractants are amphoteric or anionic phospholipids (e.g. lecithins) and anionic surfactants, as well as mixtures of these, optionally containing also non-ionic surfactants.

This invention relates to extraction and concentration of hydrophilic compounds, biological materials or particles dispersed or distributed in hydrophobic liquid matrices for the purpose of detection and/or quantification of such contaminants. This invention relates furthermore to capture solutions which improve recovery of such compounds.

### BACKGROUND OF THE INVENTION

Small amounts of hydrophilic compounds (such as ATP, NAD, NADP, NADH, NADPH, enzymes, free fatty acids, preservatives, biocides, salts) as well as micro-organisms or other particles are often dispersed or distributed in hydrophobic liquid matrices such as crude oil, vegetable oil, petrol and kerosene. Such compounds or particles may constitute a contamination or adulteration or may be additives and preservatives of which a specific concentration is required. It may therefore be desirable to detect and/or quantify such compounds, to establish whether a particular product is safe and appropriate for a particular use. The hydrophilic compounds mentioned above are summarized in the present description as hydrophilic compounds.

By performing an aqueous extraction the hydrophilic compounds can be separated from the hydrophobic matrix and detection/quantification can then be performed on the aqueous extract. To obtain a high recovery in the extraction it is important to obtain good dispersion of the aqueous extractant throughout the hydrophobic matrix. To obtain a low detection limit it is important to keep the ratio of extractant to matrix low. To obtain a fast recovery it is important to get a rapid phase separation after the extraction step. By using a capture solution according to the invention the recovery of hydrophilic compounds is greatly improved.

### DESCRIPTION OF THE INVENTION

The present invention relates to a method of extraction of hydrophilic compounds dispersed or distributed in a hydrophobic/non-polar/non-ionic liquid matrix. The present invention relates also to a capture solution.

The object of the present invention is a method for extraction and concentration of hydrophilic compounds dispersed or distributed in hydrophobic liquid matrices comprising the following steps:
a) providing a sample of a hydrophobic liquid
b) adding an aqueous capture solution containing at least one extractant to said sample
c) mixing said sample and said capture solution thoroughly
d) allow the aqueous phase to separate from the sample phase
e) measure the compound in the aqueous phase.

Another object of the invention is a capture solution containing at least one extractant in an effective concentration, said extractant being a surfactant that improves the yield of the hydrophilic compound. Preferred extractants are selected from the group consisting of amphoteric or anionic phospholipids (e.g. lecithins, phosphatidyl inositols) or anionic surfactants (e.g. sodium dodecyl sulphate (SDS), deoxycholic acid, or potassium sorbate). In especially preferred embodiments the amphoteric phospholipid is a lecithin. In most preferred embodiments the capture solution contains a water-soluble dye, thus improving the visibility of the aqueous phase.

Another object of the invention is a reagent kit for extracting a hydrophilic compound from a hydrophobic matrix and detection of said hydrophilic compound comprising a capture solution according to the present invention.

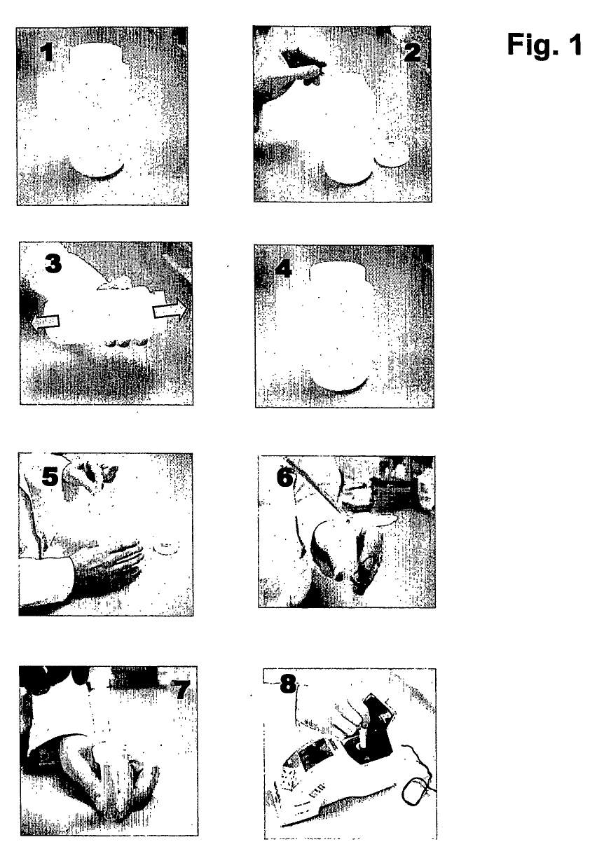

FIG. 1 depicts the procedure according to the present invention. Details are given in the examples. The steps shown are: (1) One litre of sample is collected; (2) the capture solution is added; (3) the mixture is shaken vigorously for 10 seconds; (4) the mixture then is left standing for 5 minutes; (5) the capture solution is collected; (6) the capture solution is added to a HY-LiTE® pen tube; (7) the capture solution is tested using a HY-LiTE® pen; (8) read HY-LITE® pen: the emitted light is measured in a HY-LiTE® luminometer.

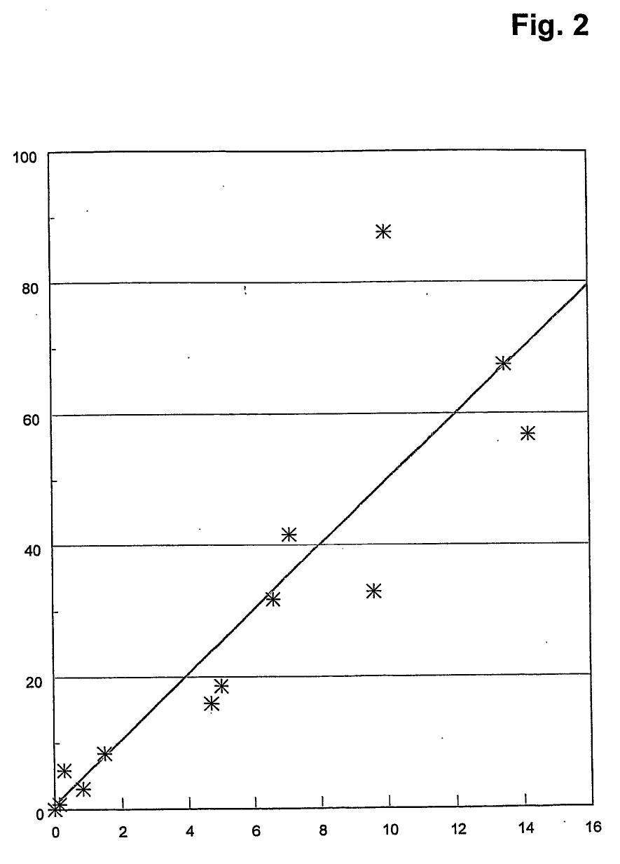

FIG. 2 shows a comparison of biomass measurements in extracts of kerosene using the extraction method according to the invention. Count of viable cells (x-axis) is compared to the luminometric determination of ATP (y-axis). Experimental details are described in example 3.

The capture solution used according to the present invention is an aqueous solution of an extractant. This capture solution optionally may contain acids, bases or buffers as additive for maintaining a defined pH and/or neutral salts in order to maintain a given ionic strength, as well as preservatives to prevent contaminating microorganisms from growing in the capture solution. The nature of such additives would depend on the nature of matrix, analyte and analytical method, but could be exemplified by:
Sodium hypochlorite—to maintain sterility before use;
Sodium Chloride—to maintain isotonic pressure in solution;
Phosphate buffer—to maintain pH in the solution;
Sodium Hydroxide—to maintain titerable alkalinity in the solution.

Other examples will be known to those skilled in the art.

A water-soluble dye can be added in order to improve the visibility of the aqueous phase. In this document the term water-soluble dye represents both dyes and fluorescent compounds, unless otherwise stated. Methylene-blue, Patent Blue V or Fluorescein are examples for such a water-soluble dye. The concentration of the water-soluble dye is chosen to allow good visibility of the aqueous phase.

The extractant is selected out of the group of tensids, surfactants, or emulsifyers. A large variation of compounds are known in the art which may be naturally occurring, derivatives of natural products or synthetic, examples are shown in the following table:

| Type of | |
|---|---|
| surfactant/ | |
| emulsifier | Examples |
| Non-ionic | Polysorbates (e.g. TWEEN (R) 20, TWEEN (R) 80), |
| | Ethoxylated 4-(1,1,3,3-tetramethylbutyl)phenol |
| | (Triton (R) X-100), Sorbitan mono-laureate, |
| | Sorbitan mono-oleate, alkyl-polyethyleneglycolether |
| | (e.g. polyethyleneglycolether of |
| | laurylalcohohl, BRIJ (R) 35) |
| Anionic | Sodium dodecyl sulphate (SDS), Sodium cholate |
| | hydrate, Phosphatidyl inositol, Deoxycholic acid |
| | Sodium salt, Sodium propionate, Potassium sorbate |
| Cationic | Benzalkonium chloride, Dodecyl trimethyl |
| | ammonium bromide, Cetyl pyrimidinium bromide, |
| | Cetyl trimethyl ammonium bromide |
| Amphoteric, | Lecithins, cephalins, |
| zwitterionic | CHAPS, CHAPSO |

Beyond the classification given above surfactants and emulsifiers can be categorized by the balance of their hydrophilic-lipophilic properties (HLB-value), or by their critical micellar concentration (CMC), or by their solubility in water.

In the art surfactants or emulsifyers are used to produce and stabilize oil in water or water in oil dispersions. In addition these substances are used to solubilize hydrophobic substances in aqueous solutions. Some other use of these substances is to disrupt biological membranes.

According to the present invention selected members out of the group of surfactants or emulsifyers are used as extractant in order to improve the extraction of hydrophilic materials out of hydrophobic matrices into aqueous solutions. It has been found that amphoteric or anionic phospholipids (e.g. lecithins, phosphatidyl inositols) or anionic surfactants (e.g. sodium dodecyl sulphate (SDS), sodium deoxych.olate, or potassium sorbate) are useful as extractants. Thereby the anionic surfactant can be added as free acid or as the appropriate salt (e.g. sodium salt) known in the art. In especially preferred embodiments the extractant is a lecithin.

A capture solution according to the invention can optionally contain more than one extractant out of the group defined above. Useful mixtures may contain neutral surfactants like polysorbates (e.g. Tween (R) 80) in addition to amphoteric or anionic phospholipids or anionic surfactants.

The effective concentration of the most preferred extractant (lecithin) used in capture solutions is preferably between 0.1% (w/v) and 1% (w/v). Using other surfactants as extractant preferred ranges depend on HLB-value and critical micellar concentration, as well as on solubility in water. For such other surfactants limits for effective concentrations can be deduced from Examples 2 and 5.

The selection of the surfactant component(s) of the capture solution depends on the sample matrix and the type of reaction used for the detection of the contaminants, e.g.: Surfactants like SDS tend to lyse cells and are therefor not very suitable if contaminating bacteria are to be detected by growth as viable cell count. In some instances the use of defined chemical entities like SDS might be advantageous over less defined mixtures like lecithins. Rapid phase separation without additional measures like vibration or centrifugation is advantageous.

Using a capture solution according to the present invention results in a recovery rate for the hydrophilic compound of more than 50%, preferably more than 80%

An example of a detailed preferred embodiment could be:

| | | |
|---|---|---|
| Soy Lecithin: | 0.50-10.00 | g |
| Methylene Blue: | 0.01-0.20 | g |
| Sodium Hypochlorite: | 0.01-0.05 | g |
| Water: | ad 1000.00 | ml |

This capture solution is extremely useful for detection of contaminants in fuels, e.g. diesel, kerosene.

A low ratio (1:10 or less; preferred: 1:100 or less; mostly preferred 1:1000 or less) of an aqueous capture solution containing an extractant is added to the sample to be tested. The lower limit for the volume ratio of the capture solution is given by the solubility of water in the sample, i.e. the volume ratio has to be large enough so that an aqueous phase can be separated from the bulk of the hydrophobic sample. Capture solution and sample is mixed to disperse the capture solution throughout the sample.

The resultant mixture is allowed to settle for a period of time to obtain phase separation. If necessary, the phase separation can be promoted by addition of a further small amount of ionic compounds (typically salt, acid or base) to break the emulsion or by physical treatment (e.g. temperature change, vibration, centrifugation).

After phase separation, the aqueous phase is retrieved and detection of the compounds, biological materials and particles can be performed as desired on the isolated aqueous phase. Methods for this purpose are known in the art. Examples are: measuring ATP by luminometry using luciferase, measuring NAD and/or NADP by cycling reactions, determining the cell count of microbes by plating defined volumes onto a suitable solid growth medium supporting the growth of the microbe to be counted. WO 02/22854 discloses a cycling reaction scheme for measuring NAD and/or NADP. For the determination of enzyme activities spectrophotometric procedures are known. Toxins, antibiotics, or growth inhibitors can be determined using biological tests like the radial diffusion test using susceptive bacteria as test organism.

Separation times may vary and may be accelerated by use of containers with smooth, hydrophobic/non-polar/non-ionic inner walls. Containers having a conical bottom allow collecting the aqueous lower phase more easily.

The extractant according to the present invention is prepared by dissolving the ingredients in distilled water.

Without further elaboration, it is believed that one skilled in the art can, using the preceding description, utilize the present invention to its fullest extent. The preferred specific embodiments and examples are, therefore, to be construed as merely illustrative, and not limitative of the disclosure in any way whatsoever.

The entire disclosures of all applications, patents, and publications cited above and below, and of corresponding application EP 03018908.8, filed Aug. 20, 2003, are hereby incorporated by reference.

### LITERATURE REFERENCES

Institute of Petroleum. Standard IP 385/99: Determination of the viable aerobic microbial content of fuels and fuel components boiling below 390° C. —Filtration and culture method

IATA: Guidance Material on Microbiological Contamination in Aircraft Fuel Tanks. 1st Edition, Effective 1 Dec. 2002

### EXAMPLES

The following examples represent practical applications of the invention.

### Example 1

### Improvement of Extraction Efficency Using Capture Solution (Extraction of ATP)

The use of the current invention to demonstrate improved extraction of free chemical from a hydrophobic liquid sample is illustrated in table 1a. The chosen sample is diesel and the marker for free chemical is ATP. 10 ml of diesel fuel are transferred to each of two bottles. 1 μl of 1.0×10⁻⁴M ATP solution is added to each of the bottles and mixed on vortex mixer for 60 seconds. 1 ml of water only is added to one bottle and 1 ml of capture solution (0.1%(w/v) Lecithin) is added to the other bottle. Both bottles are mixed on vortex mixer for 10 seconds. Bottles are left to stand for 30 minutes before removing settled water and capture solution. Free ATP in recovered water and capture solution is measured by assay using Merck KGaA bioluminescence reagents. 100% recovery is determined by adding 1 μl of 1.0×10⁻⁴M ATP directly to 1 ml of water or 1 ml of capture solution and measuring free ATP.

% recovery is calculated,

$$\% recovery = \frac{free ATP measured in water or capture solution}{free ATP measured from 100 \% recovery} \times 100$$

TABLE 1a

| extractant | % recovery |
|---|---|
| water | 3 |
| capture solution | 70 |
| (0.1% (w/v) Lecithin) | |

The above experiment is repeated using two different capture solutions (0.1% (w/v) Lecithin or 0.1% (w/v) SDS). The procedure is slightly modified: Before removing the aqueous phase the bottles are left to stand for 60 minutes (instead of 30 minutes):

TABLE 1b

| extractant | % recovery |
|---|---|
| water | 9 |
| Capture solution | 66 |
| (0.1% (w/v) Lecithin) | |
| Capture solution | 78 |
| (0.1% (w/v)SDS | |

These results show that capture solutions according to the present invention are by far better than water alone for ATP extraction and concentration of ATP from diesel.

### Example 2

### Improvement of Extraction Efficency Using Capture Solution (Extraction of Bacteria Using ATP as Marker)

The use of the current invention to demonstrate capture and subsequent measurement of biomass components in a hydrophobic liquid sample is illustrated in table 2a. The chosen sample is aviation fuel and the marker for biomass determination is Adenosine Triphosphate (ATP).

500 ml of fresh aviation fuel is measured into each of two containers. 25 μl of a bacterial suspension (Pseudomonas fluorescens) is added to each container. Both containers are manually mixed by shaking to distribute the bacteria followed by mixing on a roller mixer for 60 minutes and then finally standing for 30 minutes before testing. 0.5 ml of water only is added to one container and 0.5 ml of capture solution (0.1% (w/v) Lecithin) is added to the other container. Both bottles are mixed by shaking for 10 seconds. Containers are left for 5 mlnutes before removing the settled water and capture solution with a Pasteur pipette for testing. Total ATP in recovered water and capture solution is measured by assay using Merck KGaA bioluminescence reagents. 100% recovery is determined by adding 25 μl of same bacterial suspension directly to 0.5 ml of water or 0.5 ml of capture solution and measuring total ATP.

% recovery is calculated,

$$\% recovery = \frac{total ATP measured in water or capture solution}{total ATP measured from 100 \% recovery} \times 100$$

TABLE 2a

| extractant | % recovery |
|---|---|
| water | 26 |
| capture solution | 61 |
| (0.1% (w/v) Lecithin) | |

The above experiment is repeated using two different capture solutions (0.1% (w/v) Lecithin or 0.05% (w/v) SDS). The procedure is slightly modified: 700 ml of fresh aviation fuel is measured into each of three containers. 25 μl of a bacterial suspension (Pseudomonas fluorescens) is added to each container. All containers are manually mixed by shaking to distribute the bacteria 1.0 ml of water only is added to one container and 1.0 ml of capture solution (0.1% (w/v) Lecithin or 0.05% (w/v)SDS) is added to the other containers. All bottles are mixed by shaking for 10 seconds. Containers are left for 5 minutes before removing the settled water and capture solutions with a Pasteur pipette for testing. Total ATP in recovered water and capture solution is measured by assay using Merck KGaA bioluminescence reagents. 100% recovery is determined by adding 25 μl of same bacterial suspension directly to 1.0 ml of water or 1.0 ml of capture solution and measuring total ATP.

% recovery is calculated,

$$\% recovery = \frac{total ATP measured in water or capture solution}{total ATP measured from 100 \% recovery} \times 100$$

TABLE 2b

| extractant | % recovery |
|---|---|
| water | 48 |
| Capture solution | 94 |
| (0.1% (w/v) Lecithin) | |
| Capture solution | 92 |
| (0.05% (w/v)SDS | |

These results show that capture solutions according to the present invention are better than water alone for total ATP (biomass) extraction and concentration from aviation fuel.

### Example 3

### Extraction of Cells According to the Present Invention and Determination of Biomass Comparing Viable Cell Count and ATP Determination

The use of the current invention to demonstrate capture and subsequent measurement of free chemical and biomass components in a hydrophobic liquid sample is illustrated in table 3.

The chosen sample is aviation fuel and the marker for free chemical and biomass determination is Adenosine Triphosphate (ATP). ATP levels indicate levels of microbial contamination of the aviation fuel. Aviation fuel collected from aeroplane wing tanks is used as sample to measure ATP levels and TVC (total viable count). Fuel samples are processed as described below so that an aqueous capture solution can be tested for ATP levels and TVC.

1.0 ml of capture solution (0.1% (w/v) Lecithin) is added to approximately 1.0 L of fuel sample, fuel and capture solution are mixed by manual shaking for 10 seconds, sample is allowed to stand for 5 mlnutes before removing the settled capture solution with a disposable Pasteur pipette, capture solution is tested for ATP and TVC (FIG. 1 shows protocol for measuring ATP).

Free ATP (extracellular ATP) and Total ATP (biomass ATP+extracellular ATP) levels are measured with the HY-LiTE® ATP luminescence assay manufactured by Merck KGAA, Germany. To measure free ATP 28 μl of capture solution is pipetted into the HY-LiTE® pen (via the reagent cap) and light emission (expressed as RLU—relative light units) measured in the HY-LiTE® luminometer. Total ATP is measured by sampling the capture solution with the HY-LiTE® pen following manufacturer's instructions and light emission measured in the HY-LiTE® luminometer. TVC is determined by plating out 100 μl of neat, 10⁻², and 10⁻⁴ dilutions of capture solution on Tryptone Soy Agar plates. Plates are incubated for 2 days at 20° C. before counting colonies. Colony forming units (cfu/ml) per ml are calculated, cfu/ml=no.of colonies×dilution factor×10

TABLE 3

| | Free ATP | Total ATP | TVC |
|---|---|---|---|
| sample | (RLU) | (RLU) | (cfu/ml) |
| 1 | 1400 | 43000 | 7.1 × 10⁶ |
| 2 | 210 | 57000 | 1.42 × 10⁷ |
| 3 | 560 | 68000 | 1.35 × 10⁷ |
| 4 | 210 | 32000 | 6.6 × 10⁶ |
| 5 | 69 | 870 | 1.42 × 10⁵ |
| 6 | 76 | 6000 | 3.0 × 10⁵ |
| 7 | 81 | 8500 | 1.5 × 10⁶ |
| 8 | 30 | 16000 | 4.7 × 10⁶ |
| 9 | 380 | 19000 | 5.0 × 10⁶ |
| 10 | 91 | 3200 | 8.5 × 10⁵ |
| 11 | 340 | 88000 | 1.0 × 10⁷ |
| 12 | 100 | 33000 | 9.6 × 10⁶ |
| 13 | 36 | 76 | 0.0 × 10⁰ |
| assay | 56 | 56 | — |
| back- | | | |
| ground | | | |

Data shows that free ATP and total ATP can be extracted and concentrated from the hydrophobic phase into the capture solution at levels significantly different from assay background. Comparing the biomass ATP and the TVC one observes an excellent correlation showing that the microbes have been extracted as viable cells in reproducible yield. The correlation data are:
r=0.8872 y=0.0049293 x+676,7

The data are presented in FIG. 2.

### Example 4

### Improvement of Extraction Efficiency Using Capture Solution (Extraction of Nitrate)

The use of the current invention to demonstrate improved extraction of free chemical from a hydrophobic liquid sample is illustrated in table 4. The chosen sample is aviation fuel and the marker for free chemical is nitrate. 100 ml of fresh aviation fuel fuel is transferred to each of three bottles. 9 μl of 32.4 g/Litre Potassium Nitrate solution is added to each of the bottles and mixed by manual shaking for 10 seconds and then allowed to stand for 5 minutes. 1 ml of water only is added to one bottle and 1 ml of capture solution (0.1% (w/v) Lecithin or 0.05% (w/v) SDS) is added to the other bottles. All bottles are mixed for 10 seconds by manual shaking. Bottles are left to stand for 5 mlnutes before removing settled water and capture solution. Nitrate in recovered water and capture solution is measured using a Merck KGaA nitrate assay. 100% recovery is determined by adding 9 μl of 32.4 g/Litre Potassium Nitrate solution directly to 1 ml of water or 1 ml of capture solution and measuring nitrate.

% recovery is calculated,

$$\% recovery = \frac{nitrate ATP measured in water or capture solution}{nitrate ATP measured from 100 \% recovery} \times 100$$

TABLE 4

| Extractant | % recovery |
|---|---|
| Water | 47 |
| Capture solution | 70 |
| (0.1% (w/v) Lecithin) | |
| Capture solution | 85 |
| (0.05% (w/v)SDS | |

This result shows that capture solution is better than water alone for extraction and concentration of nitrate from aviation fuel.

### Example 5

### Extraction of ATP from a Hydrophobic Liquid Using a Variety of Extractants

The extraction of free chemical from a hydrophobic liquid sample by a variety of extractants is illustrated in tables 5 and 6. The chosen sample is diesel and ATP is used as chemical to be extracted. 10 ml of diesel fuel is transferred to each of a number of bottles. 1 μl of 1.0×10⁻⁴M ATP solution (experiment A; table 5) or 5 μl of 1.0×10⁻⁴M ATP solution (experiment B; table 6) is added to each of the bottles and mixed on vortex mixer for 60 seconds. 1 ml of water only is added to one bottle and 1 ml of the test compound solution or mixture of compounds under test is added to another bottle. All bottles are mixed on vortex mixer for 10 seconds. Bottles are left to stand for 5 mlnutes before removing settled water and test compound solution. Free ATP in recovered water and compound solution is measured by assay using Merck KGaA bioluminescence reagents. 100% recovery is determined by adding 1 μl of 1.0×10⁻⁴M ATP (experiment A) or 5 μl of 1.0×10⁻⁴M ATP (experiment B) directly to 1 ml of water or 1 ml of test compound solution and measuring free ATP.

% recovery is calculated,

$$\% recovery = \frac{free ATP measured in water or test compound solution}{free ATP measured from 100 \% recovery} \times 100$$

TABLE 5
(experiment A):

| | | % Recovery | | | | | |
|---|---|---|---|---|---|---|---|
| | | Concentration of extractant | | | | | |
| | | % (w/v) | | | | | |
| Class | Compound | 0.001 | 0.01 | 0.1 | 1.0 | 10 | N/A |
| | Water | | | | | | 11 |
| Phospholipids | Soy lecithin | 11 | | 35 | 64 | | |
| Anionic | SDS | 33 | | 70 | 47 | | |
| detergent | | | | | | | |

TABLE 6
(Experiment B):

| | | % Recovery | | | | | |
|---|---|---|---|---|---|---|---|
| | | Concentration of extractant | | | | | |
| | | % (w/v) | | | | | |
| Class | Compound | 0.001 | 0.01 | 0.1 | 1.0 | 10 | N/A |
| | Water | | | | | | 6 |
| Phospholipids | Phosphotidyl | 74 | | 78 | 65 | | |
| | inositol | | | | | | |
| Anionic | Deoxycholic acid | 6 | 35 | 88 | 48 | | |
| detergent | Sodium salt | | | | | | |
| | Sodium propionate | | | 41 | 67 | | |
| | Potassium sorbate | | | 56 | 82 | | |
| Mixtures | 0.1% Lecithin + | | | | | | 89 |
| | 0.001% SDS | | | | | | |
| | 0.1% Lecithin + | | | | | | 82 |
| | 0.1% Tween 80 | | | | | | |
| | 0.001% SDS + | | | | | | 82 |
| | 0.1% Tween 80 | | | | | | |

These results show that excellent extraction rates are obtained when using solutions containing phospholipids, anionic detergents and mixtures of these with each other or with non-ionic detergents.

### Example 6

### Extraction of ATP from a Hydrophobic Liquid Using a Variety of Other Surfactants

The experiments of Example 5 are repeated using surfactants different from extractants according to the present invention, as well as some other chemicals commonly used in extraction procedures. In experiment C, 1 μl of 1.0×10⁻⁴M ATP solution is added to bottles and 100% control and in experiment D, 5 μl of 1.0×10⁻⁴M ATP solution is added to bottles and 100% control. The results are summarized in tables 7 and 8 below.

TABLE 7
(Comparison Experiment C):

| | | % Recovery | | | | | |
|---|---|---|---|---|---|---|---|
| | | Concentration of compound | | | | | |
| | | % (w/v) | | | | | |
| Class | Compound | 0.001 | 0.01 | 0.1 | 1.0 | 10 | N/A |
| | Water | | | | | | 11 |
| Zwitterionic | CHAPS | 10 | | 7 | 4 | | |
| detergent | CHAPSO | 7 | | 8 | 8 | | |
| Non-ionic | Tween 20 | 9 | | 8 | 14 | | |
| | Tween 80 | 11 | | 18 | 12 | | |
| | Triton X-100 | 3 | | 9 | 11 | | |
| | Sorbitan mono- | 6 | | 1 | 23 | | |
| | laureate | | | | | | |
| | Sorbitan mono- | 14 | | 11 | 7 | | |
| | oleate | | | | | | |
| | Brij 35 | 7 | | 18 | 15 | | |

TABLE 8
(Comparison Experiment D):

| | | % Recovery | | | | | |
|---|---|---|---|---|---|---|---|
| | | Concentration of compound | | | | | |
| | | % (w/v) | | | | | |
| Class | Compound | 0.001 | 0.01 | 0.1 | 1.0 | 10 | N/A |
| | Water | | | | | | 6 |
| Cationic | Cetyl pyrimidinium | 2 | 4 | 40 | 42 | | |
| detergents | bromide | | | | | | |
| | Dodecyl trimethyl | 7 | 22 | 6 | 20 | | |
| | ammonium | | | | | | |
| | bromide | | | | | | |
| | Cetyl trimethyl | | 20 | 41 | 35 | | |
| | ammonium | | | | | | |
| | bromide | | | | | | |
| | Benzalkonium | 4 | 4 | 8 | 38 | | |
| | chloride | | | | | | |
| Surfactant/ | Poly vinyl alcohol | 4 | 4 | 1 | 1 | | |
| chemical | (PVA) | | | | | | |
| | Triethylene glycol | | | | 5 | 6 | |
| | (trigol) | | | | | | |
| | Diethylene glycol | | | | 3 | 2 | |
| | Poly ethylene | | | | 6 | 4 | |
| | glycol 300 | | | | | | |
| | (PEG300) | | | | | | |
| | Polyethylene glycol | | | | 6 | 3 | |
| | 4000 (PEG4000) | | | | | | |
| | DMSO | | | | 9 | 15 | |
| | Urea | | | 11 | 28 | | |
| Mixtures | 0.1% Lecithin + 0.1% | | | | | | 14 |
| | Benzalkonium | | | | | | |
| | chloride | | | | | | |
| | 0.1% Benzalkonium | | | | | | 5 |
| | chloride + 0.001% | | | | | | |
| | SDS | | | | | | |
| | 0.1% Benzalkonium | | | | | | 7 |
| | chloride + 0.1% | | | | | | |
| | Tween 80 | | | | | | |

These comparison experiments show that surfactants different from extractants according to the present invention are much less suitable for extracting hydrophilic compounds from hydrophobic matrices.

1. A method for extraction and concentration of hydrophilic compounds dispersed or distributed in hydrophobic liquid matrices comprising the following steps:
a) providing a sample of a hydrophobic liquid;
b) adding an aqueous capture solution containing at least one extractant to said sample;
c) mixing said sample and said capture solution thoroughly;
d) allow the aqueous phase to separate from the sample phase;
e) measure the compound in the aqueous phase.

2. An aqueous capture solution containing at least one extractant, said extractant in said capture solution improving the yield of a hydrophilic compound extracted from a hydrophobic matrix.

3. A capture solution according to claim 2, wherein said extractant is selected out of the group consisting of amphoteric or anionic phospholipids and anionic surfactants.

4. A capture solution according to claim 3, wherein said extractant is a lecithin.

5. A capture solution according to claim 2 containing more than one extractant.

6. A capture solution according to claim 2 containing a non-ionic surfactant in addition to the extractant(s).

7. A capture solution according to claim 2 containing a water-soluble dye in an amount to allow good visibility of the aqueous phase.

8. A reagent kit for extracting a hydrophilic compound from a hydrophobic matrix and detection of said hydrophilic compound comprising a capture solution according to claim 2.
